(19) United States
(12) Patent Application Publication
(10) Pub. No.: US 2022/0051294 A1
(43) Pub. Date: Feb. 17, 2022

(54) SYSTEMS AND METHODS FOR IDENTIFYING INTERNET USERS IN REAL-TIME WITH HIGH CERTAINTY

(71) Applicant: Wells Fargo Bank, N.A., San Francisco, CA (US)

(72) Inventor: Jay Das, West Chester, PA (US)

(21) Appl. No.: 15/435,751

(22) Filed: Feb. 17, 2017

(51) Int. Cl. G06Q 30/02; G06F 17/30; G06Q 40/02

(52) U.S. Cl. CPC G06Q 30/0269; G06Q 20/24; G06Q 40/025; G06F 17/30864

(57) ABSTRACT

A system includes a network interface configured to communicate with a user device and a processing circuit. The processing circuit is configured to receive, via the network interface, a cookie identifier and a device identifier associated with the user device and identify a profile associated with at least one of the cookie identifier and the device identifier by searching a profile database with at least one of the cookie identifier and the device identifier. The processing circuit is further configured to generate an advertisement based on the profile and transmit the advertisement to the user device to be displayed. The processing circuit prompts a user of the user device to input user identification into a user identification prompt, receives user identification from the user device, and determines that the user identification is associated with the profile by matching the user identification with information stored in the profile.

### TECHNICAL FIELD

Embodiments of the present disclosure relate generally to the field of real-time data analytics and more specifically, identifying internet users.

### BACKGROUND

The present invention relates generally to the field of targeted advertisements and in particular, using real-time data analytics and online user tracking to generate targeted advertisements. Online user tracking may be performed with device identifiers or hypertext transfer protocol (HTTP) cookies. An HTTP cookie is a piece of data that is sent from a website to an individual's internet browser. The cookie stored on the internet browser may be a tracking cookie. A tracking cookie can be used to identify internet activity of the individual by logging their web browsing activity. When the cookie logs web browsing activity, it creates a log file which can be accessed to determine the web browsing activity of the user. A device identifier may be a unique value stored on a user device. The device identifier may be used by websites or applications to monitor and track the activity of a certain device by monitoring activity associated with the device identifier.

### SUMMARY OF THE INVENTION

A first example embodiment relates to a system. The system includes a network interface configured to communicate with a user device and a processing circuit. The processing circuit is configured to receive, via the network interface, a cookie identifier and a device identifier associated with the user device and identify a profile associated with at least one of the cookie identifier and the device identifier by searching a profile database with at least one of the cookie identifier and the device identifier. The processing circuit is further configured to generate an advertisement based on the profile and transmit the advertisement to the user device to be displayed. The processing circuit prompts a user of the user device to input user identification into a user identification prompt, receives user identification from the user device, and determines that the user identification is associated with the profile by matching the user identification with information stored in the profile.

The apparatus includes a network interface configured to communicate with a user device and a processing circuit. The processing circuit is configure to receive, via the network interface, a cookie identifier and a device identifier associated with the user device and identify, in real-time, a profile associated with at least one of the cookie identifier and the device identifier by searching a profile database with at least one of the cookie identifier and the device identifier. The processing circuit is further configured to generate a pre-screened credit card advertisement when a credit score of the identified profile is above a predefined level and generate a generic credit card advertisement when the credit score of the identified profile is below the predefined level. The processing circuit is configured to cause, via the network interface, at least one of the pre-screened credit card advertisement and the generic credit card advertisement to be displayed on the user device and receive user identification from the user device. The processing circuit is further configured to determine, in real-time, that the user identification is associated with the profile by matching the user identification with information stored in the profile.

Another example embodiment relates to a method. The method includes receiving, via a network interface, a cookie identifier and a device identifier associated with the user device and identifying, by a processing circuit, a profile associated with at least one of the cookie identifier and the device identifier by searching a profile database with at least one of the cookie identifier and the device identifier. The method includes generating, by the processing circuit, an advertisement based on the profile and causing, via the network interface, the advertisement to be displayed on the user device. The method further includes receiving, via the network interface, a user identification from the user device, wherein the advertisement prompts the user to enter user identification into a user identification prompt and determining, via the processing circuit, that the user identification is associated with the profile by matching the user identification with information stored the profile.

These and other features, together with the organization and manner of operation thereof, will become apparent from the following detailed description when taken in conjunction with the accompanying drawings.

### BRIEF DESCRIPTION OF THE DRAWINGS

FIG. 1 is a schematic diagram of a communications system, according to an example embodiment.

FIG. 2 is a diagram of the financial institution computing system of FIG. 1, according to an example embodiment.

FIG. 3 is a flow diagram of a method of using the financial institution computing system of FIGS. 1-2 to identify a user, according to an example embodiment.

FIG. 4 is a flow diagram of a method of using the financial institution computing system of FIGS. 1-2 to generate an advertisement for a customer, according to an example embodiment.

FIG. 5 is a drawing of a browser displaying an advertisement hosted by the webserver of FIG. 1, according to an example embodiment.

FIG. 6 is a drawing of a browser displaying an advertisement for an identified user hosted by the webserver of FIG. 1, according to an example embodiment.

### DETAILED DESCRIPTION

Referring to the Figures generally, systems, methods, and apparatuses for identifying an online user in real-time are provided herein. More particularly, systems and methods for identifying an online user in real-time using cookie identifiers and device identifiers are provided herein. According to some embodiments, a financial institution computing system identifies device identifiers and cookie identifiers when users log in to various web services (e.g., online banking, mobile wallets, etc.) hosted and/or controlled by the financial institution computing system. When referred to herein, the term “cookie identifier” includes any identifier and/or data that can be used to identify a particular cookie installed on a user device, such as any number, alphanumeric value, and/or binary value. When referred to herein, the term “device identifier” includes any value or identifier that can be used to identify a device, such as a Unique Device Identifier (UDID), an Identifier for Advertisers (IDFA), an ANDROID® Device ID, an ANDROID® Advertising ID, a MAC address, and/or an IP address. The cookie identifiers and the device identifiers can be linked to various financial accounts of the user. In various embodiments, the cookie identifier and the device identifier are stored in a user profile database. The profile database can be a real-time database which is searchable in real-time and/or near real-time (e.g., within a predefined amount of time). By searching the database with device identifiers and cookie identifiers, the identity of a user and associated financial accounts of the identified user can be determined. Beneficially, such user identification allows the financial institution to identify users while they are browsing on a website or immediately when they click on a web advertisement. Further, various pre-screened and/or user specific advertisements can be served to the user in real-time based on the real-time identification of the user and the financial account information of the identified user. For example, when a user visits a website, the financial institution computing system can receive a device identifier and/or a cookie identifier from the website. By searching the user profile database, the financial institution determines the identity of the user in real-time. Based on the identity of the user, the financial intuition generates an advertisement specific for the user in real-time.

In various embodiments, the identity of the user is confirmed or corroborated. As an example, an advertisement served to the identified user includes a prompt box for the user to enter their name or other information into. The information entered into the prompt box is received by the financial institution computing system. The information entered into the prompt box is referred to as the “asserted information.” When referred to herein, the “asserted information” can include a full legal name, a nickname, an email address, a phone number, an account number, and any other user identification or value tied to the identity of a user. Beneficially, the identity of the user can be corroborated by the financial institution computing system by comparing the information stored in the user profile to the asserted information. This corroboration of user identity allows for the user to be identified with greater certainty. In various embodiments, the corroboration is performed in real-time, allowing the user to be immediately directed to a webpage and/or display an advertisement targeted to the identified user.

In practice, identifying a user and corroborating a user can be considered two distinct steps which can be performed sequentially. In this regard, a user can first be identified as soon as an individual begins browsing on a website. There may be an amount of time between when the user first begins browsing on the website and when the user interacts with an advertisement. By identifying a user by cookie and/or device identifier during this browsing time, when the individual does interact with the advertisement and asserts a name, the user can be immediately corroborated and can be displayed an advertisement that has been generated while the user was browsing. For this reason, the financial institution computing system can identify and generate advertisements for a user in real-time.

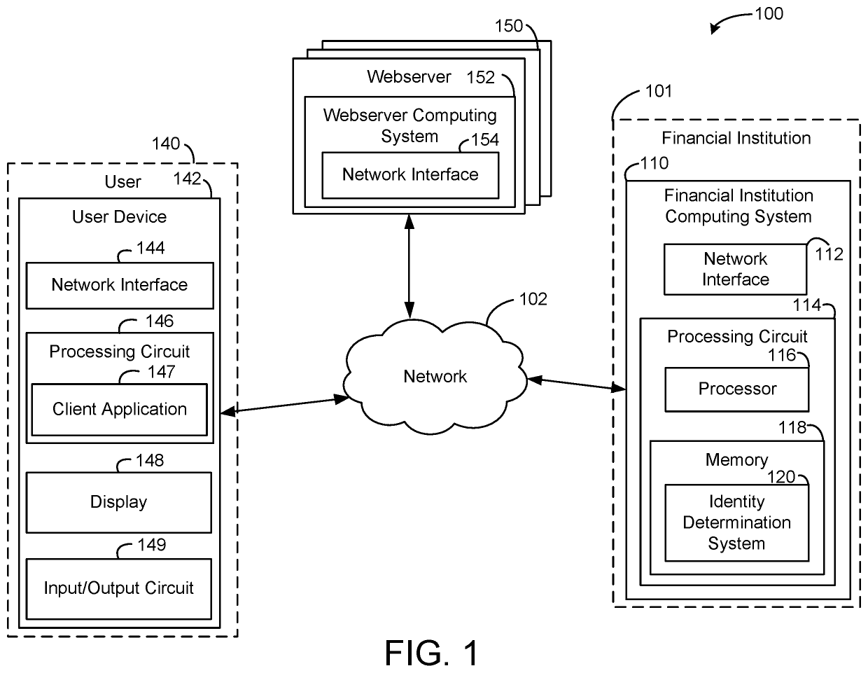

Referring now to FIG. 1, a block diagram of a system 100 is shown, according to an example embodiment. As described in further detail below, system 100 facilitates the determination of the identity of an online user, corroboration of the identity, and generation of one or more advertisements in real-time by a financial institution 101. As an example, system 100 facilitates the identification of a user by matching a cookie identifier and/or a device identifier associated with a user device with a user profile. Next, system 100 facilitates the generation of an advertisement and displays the advertisement to the user. In some embodiments, the advertisement contains a user information prompt in which the user can enter user information. In some embodiments, the user information prompt may be a name prompt which prompts a user to enter their name. System 100 can facilitate the corroboration of the identified user profile with the entered name or other user information. Next, system 100 facilitates the generation of a user specific advertisement. If the identified and corroborated user interacts with the advertisement, system 100 can serve a user specific advertisement to the user and/or direct the user to a webpage containing a user specific promotional offer. In various embodiments, the promotional offer for which the user qualifies is based on information stored in the user profile.

As shown, system 100 includes a financial institution computing system 110 associated with a financial institution 101, a webserver computing system 152 associated with a webserver 150, and a user device 142 associated with a user 140. Financial institution computing system 110 is communicably and operatively coupled to user device 142 and webserver computing system 152 via a network 102. The network 102 provides communicable and operative coupling between user device 142, webserver(s) 150 and the financial institution computing system 110, and other components disclosed and described herein to provide and facilitate the exchange of communications (e.g., data, instructions, messages, values, commands, etc.) Accordingly, the network 102 can include any network and/or combinations of networks including wired (e.g., Ethernet) and/or wireless networks (e.g., 802.11X, ZigBee, Bluetooth, WiFi, etc.). In some embodiments, the network 102 includes the Internet. In various embodiments, the network 102 includes a proprietary banking network to provide secure or substantially secure communications.

Financial institution computing system 110 includes a network interface 112 and a processing circuit 114. Network interface 112 of financial institution computing system 110 is adapted for and configured to establish a communication session via the network 102 with user device 142 and webserver 150. Accordingly, the network interface 112 includes any of a cellular transceiver (Code Division Multiple Access (CDMA), Global System for Mobile Communications (GSM), Long-Term Evolution (LTE), etc.), a wireless network transceiver (e.g., 802.11X, ZigBee, Bluetooth, etc.), or a combination thereof (e.g., both a cellular transceiver and a Bluetooth transceiver). In some embodiments, network interface 112 communicates via a secured wired connection within a branch of financial institution 101. In some arrangements, network interface 112 includes the hardware and machine-readable media sufficient to support communication over multiple channels of data communication. Further, in some arrangements, network interface 112 includes cryptography capabilities to establish a secure or relatively secure communication session with financial institution computing system 110, user device 142 and/or webserver 150. In this regard, financial data (or other types of data) can be encrypted and transmitted to prevent or substantially prevent the threat of hacking.

Processing circuit 114 includes a processor 116 and memory 118. In some embodiments, processor 116 is implemented as a general-purpose processor, an application specific integrated circuit (ASIC), one or more field programmable gate arrays (FPGAs), a digital signal processor (DSP), a group of processing components, or other suitable electronic processing components. In various embodiments, memory 118 (e.g., RAM, ROM, NVRAM, Flash Memory, hard disk storage, etc.) stores data and/or computer code for facilitating at least some of the various processes described herein. In this regard, the memory can store program logic that, when executed by processor 116, control the operation of financial institution computing system 110.

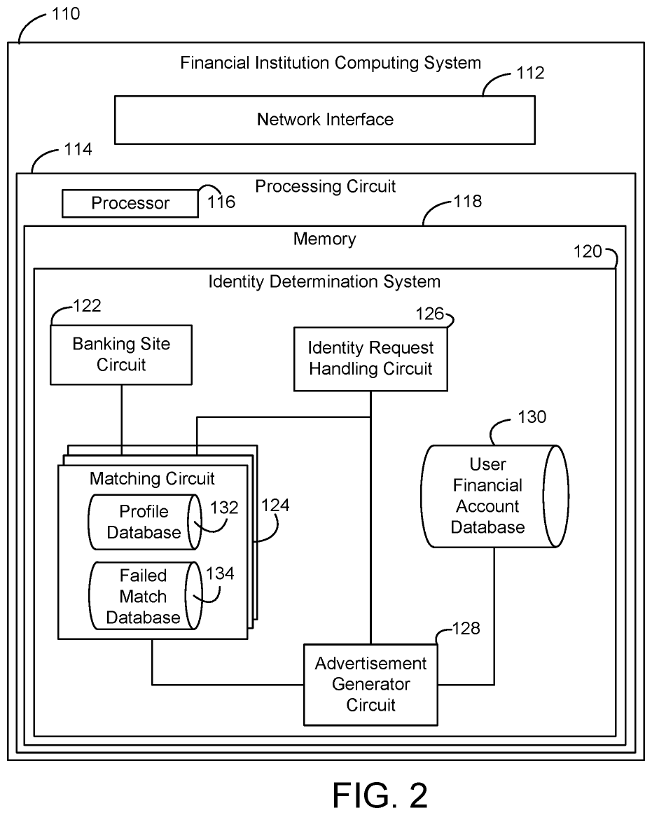

The financial institution computing system 110 further includes identity determination system 120. The identity determination system 120 identifies online users (e.g., user 140) by matching cookie identifiers and device identifiers with user profiles. Further, identity determination system 120 is configured to generate advertisements based on the profiles associated with the identified users. These and other functions of identity determination system 120 are described in regard to FIG. 2 and elsewhere herein.

User device 142 includes any type of computing device that can be used to interact with websites (e.g., interact with webserver 150). User device 142 can include any wearable and non-wearable device. Wearable devices refer to any type of device that an individual wears including, but not limited to, a watch (e.g., smart watch), glasses (e.g., eye glasses, sunglasses, smart glasses, etc.), bracelet (e.g., a smart bracelet), etc. In some embodiments, user device 142 includes any type of mobile device including, but not limited to, a phone (e.g., smart phone, etc.), and/or any type of computing devices (e.g., desktop computer, laptop computer, personal digital assistant, etc.).

As shown, user device 142 includes a network interface 144, a processing circuit 146, a display 148, and an input/output circuit 149. Network interface 144 of user device 142 is adapted for and configured to establish a communication session via the network 102 with financial institution computing system 110 and webserver computing system 152. Accordingly, network interface 144 includes any of a cellular transceiver (Code Division Multiple Access (CDMA), Global System for Mobile Communications (GSM), Long-Term Evolution (LTE), etc.), a wireless network transceiver (e.g., 802.11X, ZigBee, Bluetooth, etc.), or a combination thereof (e.g., both a cellular transceiver and a Bluetooth transceiver). In some embodiments, network interface 144 communicates via a wired connection (e.g., Ethernet) and/or a secured wired connection within a branch of financial institution 102.

Processing circuit 146 can include and/or be implemented as a general-purpose processor, an application specific integrated circuit (ASIC), one or more field programmable gate arrays (FPGAs), a digital signal processor (DSP), a group of processing components, or other suitable electronic processing components. In various embodiments, processing circuit 146 includes memory (e.g., RAM, ROM, NVRAM, Flash Memory, hard disk storage, etc.) that can store data and/or computer code for facilitating at least some of the various processes described herein. In this regard, the memory can store programming logic that, when executed by a processor of processing circuit 146, control the operation of user device 142.

Processing circuit 146 is shown to include a client application 147. Client application 147 can be structured to perform online web browsing and/or connect with an online financial account of user 140. In this regard, client application 147 can be or include a web browsing application which allows user device 142 to communicate with webserver computing system 152 or financial institution computing system 110. In various embodiments, client application 147 can store and/or install cookies it receives from webserver computing system 152 and/or financial institution computing system 110. Client application 147 can be configured to receive data in the form of images, text, videos, webpages, etc. from webserver computing system 152 and/or processing circuit 146. Client application 147 can be configured to display the data to user 140 via display 148. Further, web browsing navigation requests can be received by client application 147 and sent to at least one of webserver computing system 152 and/or financial institution computing system 100. In some embodiments, the browsing requests are received from display 148.

The display 148 is used to present information to a user (e.g., user 140) and receive information from the user. In some embodiments, display 148 is a touch screen interface, a screen, and/or a combination of physical buttons and a display. In some embodiments, display 148 is a capacitive touch screen (e.g., a single-touch touch screen, a multi-touch touch screen, etc.), a resistive touch screen, and/or any other type of touch screen. In some embodiments, the information presented on display 148 is financial account information, transaction information, websites, advertisements and the like. In this regard, the display 148 is communicably and operatively coupled to processing circuit 146 to provide a user interface for receiving and displaying information on user device 142. Further, display 148 can receive website information from webserver(s) 150 via network interface 144. In various embodiments, user 140 interacts with advertisements via display 148 and enters text into a text box of the advertisement. The entered text can be an identifier, a name, an email address, a phone number, an account number and/or any other information.

Input/output circuit 149 is structured to receive and provide communication(s) to a user (e.g., user 140) of the user device 142, to webserver computing system 152, and/or financial institution computing system 110. Accordingly, in one embodiment, the input/output circuit 149 includes an input/output device such as a display device and/or touchscreen (e.g., display 149), a keyboard, and a microphone. In another embodiment, the input/output circuit 149 includes communication circuitry for facilitating the exchange of data, values, messages, and the like between an input/output circuit 149 and the components of the webserver computing system 152 and/or financial institution computing system 110. In yet another embodiment, the input/output circuit 149 includes machine-readable media for facilitating the exchange of information between the input/output device and the components of user device 142. In still another embodiment, the input/output circuit 149 includes any combination of hardware components (e.g., a touchscreen), communication circuitry, and machine-readable media. In this regard, the input/output circuit 149 is structured to exchange data, communications, instructions, etc. with an input/output component of user device 142.

Input/output circuit 149 sends browsing commands to web server 150 and/or financial institution computing system 110 via network interface 144. Further, input/output circuit 149 receives browsing data from webserver 150 and/or financial institution computing system 110. Webserver computing system 150 and/or financial institution computing system 110 can send browsing data to input/output circuit 149 which input/output circuit 149 can display on display 148. In some embodiments, input/output circuit 149 causes display 148 to display web pages, advertisements, and/or any other kind of information and/or web browsing data. In this regard, user 140 can use user device 142 to interact with various resources of a website such as advertisements placed on websites hosted by webserver 150. Interacting with an advertisement can include, but is not limited to, clicking on the advertisement, hovering over the advertisement with a cursor, typing text (e.g., the asserted information) into the advertisement, etc.

Webserver 150 is structured and configured to host websites and allow users to interact with websites via a user device (e.g., user device 142) and a network (e.g., network 102). Each webserver 150 can host a single website or multiple websites via a webserver computing system 152 which can connect the websites to a network or the Internet (e.g., network 102). In this regard, webserver computing system 152 is communicably coupled with the financial institution computing system 110 and user device 142. Accordingly, webserver computing system 152 includes a network interface 154. Network interface 154 includes any of a cellular transceiver (Code Division Multiple Access (CDMA), Global System for Mobile Communications (GSM), Long-Term Evolution (LTE), etc.), a wireless network transceiver (e.g., 802.11X, ZigBee, Bluetooth, etc.), or a combination thereof (e.g., both a cellular transceiver and a Bluetooth transceiver). In some embodiments, the network interface 154 communicates via a secured wired connection within a branch of the financial institution 110.

The webserver computing systems 152 is configured to handle web browsing requests received from a device or system (e.g., user device 142, financial institution computing system 110, etc.) and send web browsing data to the device or system. The web browsing data, which webserver computing systems 152 sends to user device 142, can include, but is not limited to, webpages, advertisements, images, videos, text, documents, etc. Any interaction user device 142 has with the web browsing data can be monitored and responded to by webserver computing system 152. In various embodiments, the interactions which webserver computing system 152 monitors includes, but is not limited to, page clicks, link clicks, advertisement clicks, text entered into text boxes, mouse pointer location and movement, etc. For example, if a user 140 of user device 142 clicks on an advertisement, webserver computing system 152 is configured to navigate a browser of the user device to a domain associated with the advertisement and/or otherwise tied to the advertisement.

Webserver computing system 152 is further configured to track a user with a web cookie and/or via a device identifier. Webserver computing system 152 can be commanded by financial institution computing system 110 to serve advertisements to user 140 via web pages (e.g., web browsing data). In some embodiments, the advertisements are generated by financial institution computing system 110 and sent to webserver computing system 152 via network 102. In such embodiments, webserver computing system 152 receives the advertisement generated by financial institution computing system 110 and receives a command that causes the webserver computing system 152 to serve the advertisement to a user.

Referring now to FIG. 2, financial institution computing system 110 is shown in greater detail, according to an example embodiment. The financial institution computing system 110 includes a processing circuit 114 having a processor 116 and memory 118 and a network interface 112 as described with reference to FIG. 1. Memory 118 is shown to include identity determination system 120 as described with reference to FIG. 1 and elsewhere herein. Identity determination system 120 includes banking site circuit 122, matching circuit(s) 124, identity request handling circuit 126, advertisement generator circuit 128, and user financial account database 130. These circuits and other circuits can be used to perform the various functions of identity determination system 120.

Identity determination system 120 is structured and configured to match a user profile to a cookie identifier, a device identifier, asserted information, and/or any other piece of data to generate an advertisement based on the user profile. Identity determination system 120 receives cookie identifiers or device identifiers from webserver(s) 150 via network interface 112. Based on the identifier received, identity determination system 120 matches the identifier to a profile linked to the identifier. Based on information associated with that profile, a user specific advertisement can be generated by identity determination system 120. In various embodiments, the user specific advertisement can include a pre-screened financial offer (e.g., a pre-screened credit card offer, a pre-screened second mortgage, a pre-screened loan, etc.).

In some embodiments, identity determination system 120 receives an identification request from webserver 150 and/or an identification request generated by financial institution computing system 110. In some embodiments, the identification request includes a request for information associated with a user (e.g., user 140) and/or a request for an advertisement for the user. In various embodiments, the request includes a request for an advertisement generated by financial institution 101. In some embodiments, the identification request includes a device identifier (e.g., a MAC ID, an IP address, an UDID, an IDFA, an ANDROID® ID, and ANDROID® Advertising ID, etc.). In various embodiments, the request includes a cookie identifier. The cookie identifier can be a banking cookie placed on a device (e.g., user device 142) by financial institution 110 and/or any other cookie stored on user device 142.

The banking site circuit 122 is structured to allow an online user to interact with various online accounts that the user has with financial institution 101. The banking site circuit 122 can be communicably coupled to user device 142 via network interface 112 and network 102. In this regard, banking site circuit 122 includes and/or controls an online web interface for viewing account balances, paying bills, applying for credit cards, applying for loans, applying for accounts with financial institution 101 and/or any other online banking activity via user device 142.

In some embodiments, banking site circuit 122 is linked or otherwise coupled to one or more accounts held by a user (e.g., user 140). In some embodiments, banking site circuit 122 permits management of the associated account (e.g., transfer balances between accounts, view payment history, etc.). In various embodiments, in response to a mobile payment via a mobile wallet of user device 142, banking site circuit 122 updates a payment account (e.g., the account that supported the mobile payment). In some embodiments, banking site circuit 122 includes and/or controls a website associated with the financial institution. In various embodiments, the website requires and/or allows a user (e.g., user 140) to login to the website via a username and password. The account associated with the username and password can contain personal information of the user (e.g., full legal name, SSN, credit scores, mortgage information, employment status, income, account balances etc.).

Banking site circuit 122 is further structured to place and retrieve identifiers on user device 142. In some embodiments, when a user (e.g., user 142) connects to a website hosted and/or controlled by banking site circuit 122 via user device 142, banking site circuit 122 places a bank tracking cookie onto a web browser (e.g., web browser stored and/or operated by processing circuit 146). In various embodiments, banking site circuit 122 identifies the tracking cookies already installed on the web browser of the user device 142. In some embodiments, the banking site circuit retrieves information (e.g., browsing log, cookie identifier, etc.) from the cookies installed on the web browser of the user device. Banking site circuit 122 can send cookie identifiers associated with cookies stored on the user device 142 to matching circuit 124 as described further herein. In this regard, the banking site circuit 122 is communicably and operatively coupled to the matching circuit 124 and components therein (e.g., profile database 132, failed match database 134). In various embodiments, the banking site circuit retrieves a device identifier (e.g., a MAC ID, an IP address, an UDID, an IDFA, an ANDROID® ID, and ANDROID® Advertising ID, etc.) from the user device 142. Banking site circuit 122 can cause matching circuit 124 to store one or more cookie identifiers and one or more device identifiers for one or more devices (e.g., user device 142) in a data structure and/or profile for an identified user 140 (e.g., in the profile database 132). The data structure and/or profile can be linked to financial information for the user 140 stored in user financial account database 130. Each profile can include the name of a user (e.g., user 140), an email address of the user, a phone number of the user, an account number of the user, and/or any other information relating to the user.

In some embodiments, when user 140 logs into their financial account through banking site circuit 122 and client application 147, a user profile associated with user 140 and any relevant legal or financial information associated with user 140 can be identified by banking site circuit 122. When the user is logged in and/or authenticated, banking site circuit 122 can retrieve all cookie identifiers and/or device identifiers associate with user device 142 and store the cookie identifiers and/or the device identifiers in the profile associated with the user that is logged in. When the user is logged into their financial account, banking site circuit 122 places a cookie on the web browser user device 142. Banking site circuit 122 retains the identity of the cookie (e.g., a cookie ID) and stores the identity of the cookie in the profile associated with the logged in user.

Matching circuit 124 is structured to match a cookie identifier, a device identifier, user information (e.g., name, phone number, account number, etc.), asserted information, and/or any other information to a user profile and send the identified profile information and/or name associated with the identified profile to the advertisement generator circuit 128. As such, the matching circuit 124 is communicably coupled to the advertisement generator circuit 128. Matching circuit 124 can receive the cookie identifier, the device identifier, and/or the asserted information from identity request handling circuit 126. Matching circuit 124 includes a profile database 132 storing one or more user profiles. The user profiles include the full legal name of a user (e.g., user 140), an SSN, cookie identifiers associated with user device 142, and device identifiers associated with the user device, the credit score of a user, the mortgage information of a user, etc. Matching circuit 124 can search profile database 132 based on user name, cookie identifier, device identifier, and/or any other value or identifier. When there is a match of at least one of the user name, the cookie identifier, and the device identifier, a user profile is identified and the identified profile and/or name of the user is sent to the advertisement generator circuit 128.

In some embodiments, matching circuit 124 stores a record (e.g., user profile) of all known users with accounts with financial institution computing system 110, all known device identifiers associated with devices of the user, and all known cookie identifiers associated with the devices of the user. Matching circuit 124 can use a probabilistic and/or deterministic searching method to match the device identifier and the cookie identifier with a user profile. In various embodiments, the identification request only includes the device ID. When the identification request only includes the device ID, matching circuit 124 can be configured to attempt to match the device identifier to a known device identifier linked to and/or stored in a user profile. In various embodiments, the matching circuit 124 can be configured to match a cookie identifier to a known cookie identifier linked to a user profile.

Profile database 132 is structured to store and search for user profiles. In some embodiments, profile database 132 is a real-time database which can be searched in real-time by matching circuit 124 (e.g., in a predefined amount of time) with explicit or implicit time constraints. The real-time database can employ scheduling algorithms and utilize hard deadlines and soft deadlines which may be associated with the matching request. In various embodiments, the database is a high performance NoSQL database and/or any other type of combination of database types. Profile database 132 can be a hosted database stored separate from financial institution computing system 110.

In various embodiments, identity determination system 120 includes one or more matching circuit(s) 124. Accordingly, multiple matching circuit(s) 124 allows identity determination system 120 to identity users faster. With multiple matching circuit(s) 124, identity determination system 120 can identity a user or a profile in real-time. Matching circuit(s) 124 can receive one or more cookie identifiers and one or more device identifiers as part of a single identification request. In some embodiments, each matching circuit 124 searches one cookie and/or one device identifier simultaneously. This may allow for matching circuits(s) 124 to simultaneously search multiple cookie identifiers and multiple device identifiers. Once one of the matching circuit(s) 124 identifies a user based on at least one of the cookie identifiers, the matching circuit 124 that identifies the user sends the user identity (e.g., user profile) to advertisement generator circuit 128 and the other matching circuit(s) 124 stop searching.

In some embodiments, the matching circuit 124 is configured to handle multiple search requests simultaneously. Handling multiple search requests simultaneously allows for searches to be performed faster or in real-time. In some embodiments, each matching circuit 124 is identical. In various embodiments, the matching circuit 124 is unable to identify a user, a second matching circuit 124 attempts the same search. If a predefined number of matching circuits 124 do not identify the user, the matching circuits 124 conclude that the cookie identifiers and/or the device identifiers used to search matching circuit 124 cannot be linked to a user associated with a financial account of the institution. In some embodiments, matching circuit(s) 124 store a list of cookie identifiers and/or device identifiers that have failed to successfully match. In some embodiments, in response to a request to match a cookie identifier and/or device identifier that has previously failed to match, matching circuit 124 does not attempt the request and sends a message to the requesting server (e.g., webserver 150, financial institution computing system 110, etc.) that the cookie identifier and/or device identifier do not match with a known user. In various embodiments, matching circuit 124 sends a message to advertisement generator circuit 128 that the user could not be identified.

Failed match database 134 is structured to store and search through the list of cookie identifiers, device identifiers, user identification, asserted information, etc. that have failed to be successfully matched by matching circuit 124. In some embodiments, failed match database 134 is a high performance NoSQL database and/or any other type or combination of database types. In various embodiments, failed match database 134 is a real-time database and allows the database to be searched in real-time with explicit or implicit time constraints. The real-time database can employ scheduling algorithms and utilize hard deadlines and soft deadlines. In some embodiments, failed match database 134 is a hosted database and/or is stored on financial institution computing system 110. The failed match database 134 can include a list of all or some cookie, name and/or device identifiers that did not match a user profile stored in profile database 132.

Matching circuit 124 searches asserted information. The asserted information can be received through a prompt box of an advertisement. In some embodiments, matching circuit 124 is configured to search the profile database 132 to determine if the asserted information matches the information (e.g., name, phone number, email address, account number, etc.) stored in one of the user profiles stored in profile database 132. If matching circuit 124 determines that the asserted information matches a user profile, matching circuit 124 can be configured to send a confirmation response to the webserver (e.g., webserver 152) that initiated the match request. If matching circuit 124 determines that the asserted information does not match a user profile, matching circuit 124 can be configured to a send a response to the webserver and/or advertisement generator circuit 128 indicating that the name did not match a user profile stored by profile database 132. In some embodiments, searching the asserted information is used to corroborate a previous user identity search. For example, a device identifier and/or cookie identifier is searched and a profile linked to the device identifier or the cookie identifier is identified. Based on the profile, an advertisement can be generated and served to a user.

In some embodiments, the advertisement prompts user 140 to enter their email address into a box on the advertisement. Once an email address is entered, the identity of the user can be corroborated by determining if the user profile contains the email address entered into the box on the advertisement. Once the email address is corroborated, the advertisement may display a second advertisement and/or direct the user to a domain that includes a pre-screened offer.

Matching circuit 124 can be further structured to search a failed match database 134. Further, matching circuit 124 can be configured to store any failed match requests (e.g., a match request which did not identify a user) in failed match database 134. By searching failed match database 134, matching circuit 124 can improve the time it takes to process matching requests. By identifying cookie identifiers, device identifiers, and/or an asserted information on the front end (e.g., before searching profile database 132) processor cycles of financial institution computing system 110 can be saved and not wasted on a match request that will fail.

In some embodiments, matching circuit 124 can search a failed match database 134 simultaneously to searching profile database 132. If matching circuit 124 identifies a user profile in profile database 132 before the search is concluded in failed match database 134, the search of failed match database 134 is terminated. If failed match database 134 identifies a cookie identifier, asserted information, and device identifier that is not linked to one of the user profiles before the search for the user profile is completed, the matching circuit 124 terminates the search for the use profile. Whenever matching circuit 124 receives a match request, a pre-search action can be performed. The pre-search action can be searching failed match database 134. If the cookie identifier and/or the device identifier are stored in failed match database 134, matching circuit 124 does not proceed with searching for the identity of the user linked to the cookie identifier and/or the device identifier in profile database 132.

Matching circuit 124 is configured to search a portion of the identification requests received in failed match database 122. In some embodiments, matching circuit 122 randomly or pseudo-randomly selects an identification request from a plurality of identification requests. Matching circuit 124 can be configured to reply to search request faster by selectively searching failed match database 122. In some embodiments, if the matching circuit 124 is searching profile database 132 and has a queue of match requests waiting to be searched through profile database 132, matching circuit chooses one or more of the queued match requests to be searched through failed match database 134.

Advertisement generator circuit 128 is configured to generate an advertisement that is relevant to a user identified by matching circuit 124 and/or the user corroborated by matching circuit 124. In this regard, advertisement generator circuit 128 is communicably coupled to matching circuit 124 and webserver 150. Further, the generated advertisement can be sent to webserver 150 and/or any other third party server or system to be displayed to the user. Advertisement generator can control the advertisement and/or monitor the advertisement via webserver 150.

In some embodiments, advertisement generator circuit 128 is configured to select an advertisement for the user identified by matching circuit 124 based on financial information (e.g., credit score, employment status, etc.). In some embodiments, advertisement generator circuit 128 can be configured to generate and/or select a generic advertisement if matching circuit 124 has failed to identify the user and/or if advertisement generator circuit 128 has not yet corroborated the identity of the user. In some embodiments, advertisement generator circuit 128 causes a user device (e.g., user device 142) to display the advertisement and/or causes a webserver (e.g., webserver 150) to display the advertisement to the user of user device 142. In various embodiments, advertisement generator circuit 128 causes financial institution 110 and/or webserver 150 to display the advertisement on a website which user 140 has navigated to via user device 142. In some embodiments, advertisement generator circuit 128 can be configured to communicate with various data management platforms (DMPS) and/or any other system and/or server that stores click data, web-browsing history, and/or any other type of data indicative of web-browsing activity of a user (e.g., an identified user). In this regard, advertisement generator circuit 128 can be configured to retrieve the web-browsing activity from the DMP and select and/or generate an advertisement for the user based on the web-browsing activity. For example, a user may visit travel websites at a high frequency within a predefined time period. In this regard, advertisement generator circuit 128 may generate a pre-screened offer for a travel credit card.

The advertisement generated by advertisement generator circuit 128 can include an information prompt. This information prompt may be a prompt for a user (e.g., user 140) to enter their name, email address, phone number, and/or any other information. The advertisement generated by advertisement generator circuit 128 can cause a webserver (e.g., webserver 150) to prompt user 140 to enter information into the prompt box. In some embodiments, the advertisement continuously prompts the user to enter information. The advertisement can prompt the user to enter information after the user interacts with the advertisement (e.g., hovers over with their cursor, clicks, etc.) When the user enters information into the box, advertisement generator circuit 128 receives the entered information. In various embodiments, webserver 150 receives the asserted information and sends the asserted information to advertisement generator circuit 128. Advertisement generator circuit 128 can be configured to cause matching circuit 124 to corroborate the identity of the user with the asserted information received from the advertisement. In various embodiments, generator circuit 128 stores a log of all advertisements that it has generated and the identity of the user which the advertisement was generated for. In these embodiments, generator circuit 128 can be configured to corroborate the identity of the user independent of matching circuit 124.

In some embodiments, if the identity of a user has been corroborated, advertisement generator circuit 128 determines if the user is eligible for a pre-screened offer (e.g., credit card offer, pre-screened loan offer, etc.). Advertisement generator circuit 128 can be configured to serve an appropriate advertisement to the identified user and/or cause the identified user to be navigated to a website with an offer appropriate for the identified user if the user interacts with the advertisement. If the user is not eligible for the pre-screened offer, advertisement generator circuit 128 can be configured to generate and/or server a generic advertisement to the user. If the asserted information does not match the user identified by matching circuit 124 such that the corroboration has failed, advertisement generator circuit 128 can generate and serve a generic advertisement to the unidentified and/or uncorroborated user. An advertisement generated for a corroborated user verses a user that could not be corroborated can be differed.

Advertisement generator circuit 128 is configured to retrieve financial information for the identity of the user determined by matching circuit 124 from user financial information database 130. In some embodiments, user financial account database 130 receives an information request from advertisement generator circuit 128 to retrieve account and/or personal information associated with an identified user profile. In some embodiments, determining and/or generating an advertisement for the user is based off of information associated with the financial account of the identified user. For example, if a user has a good credit score, such as a credit score above a predefined level, the advertisement generated and/or selected for the user can be a pre-screened credit card offer. In some embodiments, any information (e.g., employment status, bank account funds, income, etc.) associated with the identified and/or corroborated user are used to determine if the user is eligible for a pre-screened credit card offer. In various embodiments, the identified user is eligible for an equity line of credit (ELOC) based on mortgage payments of the identified user. In some embodiments, advertisement generator circuit 128 selects an advertisement that a user is most suited for the user.

In some arrangements, the advertisement generator circuit 128 is configured to underwrite a pre-screened credit card offer for the user. The advertisement generator circuit 128 uses financial information stored in the user financial account database 130, including credit scores, credit history, and other financial information to generate a pre-screened credit card offer for the user. In this way, the advertisement generator circuit 128 can display credit card offers that have already been approved for the user using the financial information stored in the user financial account database 130.

In various embodiments, user financial information database 130 stores information associated with all or some of the financial accounts of one or more individuals and/or one or more user profiles stored by profile database 132. In some embodiments, the information is name, age, residence address, credit score, bank account funds, mortgage information, etc. In some embodiments, user financial account database 130 is configured to reply to an information request by advertisement generator circuit 128 by retrieving the requested information and sending the information to advertisement generator circuit 128.

Identity request handling circuit 126 is configured to handle or queue any requests for identifying or corroborating a user received from webserver computing system 152. Based on the requests in the queue, identity request handing circuit 126 can cause matching circuit 124 to identify an online user based on the request. Accordingly, the identity request handling circuit 126 is communicably coupled to the matching circuit 124 to perform these functions. In some embodiments, the requests are queued based on average site browsing time. For example, if a website has a low average site browsing time, that website's request can be placed higher in the queue so that a user browsing on the site can be targeted quickly. If a website has a long average site browsing time, that website's request is placed lower in the queue to allow more time for critical requests to be addressed first. In some embodiments, the request comes from a third party entity (e.g., webserver 150). In some embodiments, the request comes from an entity owned by financial institution 101 (e.g., webserver 150). The third party entity can be a webserver and/or any other entity which can serve advertisements to a user. In some embodiments, the third party entity is structured and configured to store cookies, retrieve cookie identifiers, and/or retrieve device identifiers. In various embodiments, the identity request handling circuit 126 can receive identity requests from a third party entity. In various embodiments, the identity request handling circuit 126 can be configured to provide payments to the third party entity for displaying an advertisement generated by advertisement generator circuit 128.

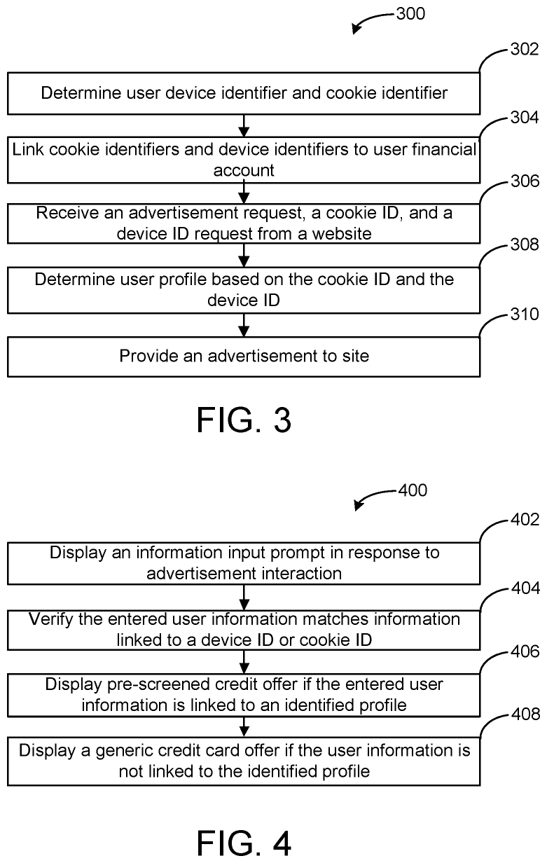

Referring now to FIG. 3, a process 300 is shown for identifying a user and generating and/or selecting an advertisement for the identified user, according to an example embodiment. Process 300 can be performed by financial institution computing system 110 described in detail in FIGS. 1-2. Reference to FIGS. 1-2 may be made to one or more components of FIGS. 1-2 in explaining process 300.

A user device identifier and cookie identifier are determined at 302. The banking site circuit 122 is configured to determine a device identifier and send a cookie of the user device. In some embodiments, when a user sets up or accesses an online banking account with the financial institution 101, banking site circuit 122 records at least one of a device identifier (e.g., a MAC ID, an IP address, an UDID, an IDFA, an ANDROID® ID, and ANDROID® Advertising ID, etc.) and any cookie identifiers on the user device and associates the device identifiers and cookie identifiers with the account of the user. In various embodiments, the banking site circuit 122 can be configured to send a cookie to the device with which the user sets up or accesses the online account. In some embodiments, financial institution computing system 110 communicates with a mobile banking application and/or mobile wallet application. The applications can retrieve the device identifier for the device and send the device identifier to financial institution computing system 110. In various embodiments, financial institution computing system 110 retrieves cookie identifiers from a web browser of the user device.

A cookie identifier is linked to the account of a user in 304. The cookie identifiers retrieved and/or sent to the user device are linked to the account of the user and stored by matching circuit 124 in profile database 132. Similarly, any device identifiers retrieved from the user device by banking site circuit 122 are stored in profile database 132 and linked to the account of the user. In some embodiments, financial institution computing system 110 performs process 302 and 304 whenever a user visits and/or logs into financial institution computing system 124, after a predetermined number of logins, etc.

A request to generate an advertisement can be received at 306. The identity request handling circuit 126 receives the request for an advertisement recommendation from webserver computing system 152. In some embodiments, the request includes a cookie identifier and/or a device identifier. In some embodiments, the request is from webserver computing system 152. Webserver computing system 152 identifies a user device (e.g., user device 142) based on at least a cookie identifier and/or a device identifier. In various embodiments, webserver computing system 152 stores webserver cookies on the user device.

A user profile is determined based on a cookie identifier and/or a device identifier at 308. Matching circuit 124 identifies the online user based on the cookie identifier and/or the device identifier received. In some embodiments, at least one of the cookie identifier and/or the device identifier are linked to a financial account of an individual. Matching circuit 124 can be configured to perform a matching routine (e.g., a probabilistic matching routine and/or a deterministic matching routine) to identify a financial account associated with the user. In some embodiments, the matching routine is based on at least one of the cookie identifier and/or the device identifier. The cookie identifier can be matched to one or more cookies linked to the user profile stored in profile database 132. The device identifier can be matched with one or more device identifiers linked to the user stored in profile database 132.

An advertisement for an identified user is generated at 310. Advertisement generator circuit 128 generates the advertisement for the identified user. The advertisement can be generated and/or selected by financial institution computing system 110 based on the financial accounts associated with the user. In some embodiments, the financial institution computing system 110 generates and/or selects a pre-screened credit card offer, a generic credit card offer, a retirement plan, a second mortgage, and/or any other advertisement based on the financial accounts and/or personal information linked to the known individual.

Referring now to FIG. 4, a process 400 is shown for serving a pre-screened credit card offer to a user is shown, according to an example embodiment. Process 400 may be performed by financial institution computing system 110 and/or webserver computing system 152 as described in detail in FIGS. 1-2. Reference to FIGS. 1-2 may be made to one or more components of FIGS. 1-2 in explaining process 400.

An information input prompt is displayed at 402. The advertisement is hosted via webserver 150 and/or financial institution computing system 110. In some embodiments, the advertisement is a pre-screened or generic credit card offer. In some embodiments, the advertisement is served to a user who has been identified as described in regard to process 300. In some embodiments, the advertisement for the pre-screened or generic credit card offer is hosted by webserver computing system 152 or financial institution computing system 110. At process 402, the identification of the user can be confirmed by requesting the user enter their name and/or any other identifier into a prompt box. If the advertisement is hosted by webserver computing system 152, the webserver computing system 152 sends the entered name or identifier to the financial institution computing system 110.

The user information entered into the prompt is verified at 404. Matching circuit 124 or advertisement generator circuit 128 determines if the user identified at process 300 matches the asserted information. In some embodiments, network interface 112 receives the identifier entered in the prompt. The entered identifier can be sent to matching circuit 124 or advertisement generator circuit 128. In some embodiments, matching circuit 124 or advertisement generator circuit 128 can match the identifier with identifiers associated with the user identified in process 300. If matching circuit 124 or advertisement generator circuit 128 determines that the entered identifier matches the identifiers associated with the profile identified at process 300, matching circuit 124 or advertisement generator circuit 128 sends a message to advertisement generator circuit 128 indicating that the user has been identified and corroborated. If matching circuit 124 determines that the entered name does not match the identity of the user identified in process 300, matching circuit 124 sends a message to advertisement generator circuit 128 indicating that the user has not been properly identified.

A credit card offer is generated at 406. Advertisement generator circuit 128 is configured to generate an advertisement for the user identified at process 300. In some embodiments, the advertisement is a pre-screened credit card offer and/or a generic credit card offer. In some embodiments, a pre-screened credit card offer and/or generic credit card offer is sent to the webserver 152. Advertisement generator circuit 128 can be configured to generate a pre-screened credit card offer for the identified user when the identity of the user determined in process 300 matches the entered name of the user as determined by matching circuit 124 or advertisement generator circuit 128. In some embodiments, advertisement generator circuit 128 sends a message to the webserver to cause the identified and corroborated user to be directed or navigated to a webpage displaying a pre-screened credit card offer if the identified user is eligible for a pre-screened credit card offer and has interacted with the advertisement used to corroborate the identity of the user. In some embodiments, the identified user is eligible for a pre-screened credit card offer when the credit score of the identified user is above a predefined threshold. In some arrangements, the credit card offer has already been through an underwriting process performed by the advertisement generator circuit 128 at the financial institution 101 using financial information stored in the user financial accounts database 130.

A generic credit card offer is generated at 408. The credit card offer is generated by advertisement generator circuit 128. If the user identified in process 300 does not match the name entered in process 402, advertisement generator circuit 128 can be configured to generate and/or select a generic credit card offer. The generic credit card offer is sent to webserver computing system 152. In some embodiments, advertisement generator circuit 128 sends a message to the webserver to cause the unidentified and/or unconfirmed user to be directed or navigated to a generic credit card offer page. In some embodiments, a generic credit card offer is applicable for any user and is not a pre-screened offer. Also, if the user is identified and/or confirmed but the user does not qualify for a pre-screened credit card offer, the user is directed to the generic credit card offer page. In some embodiments, the identified user does not qualify a pre-screened credit card offer when the credit score of the identified user is below a predefined threshold.

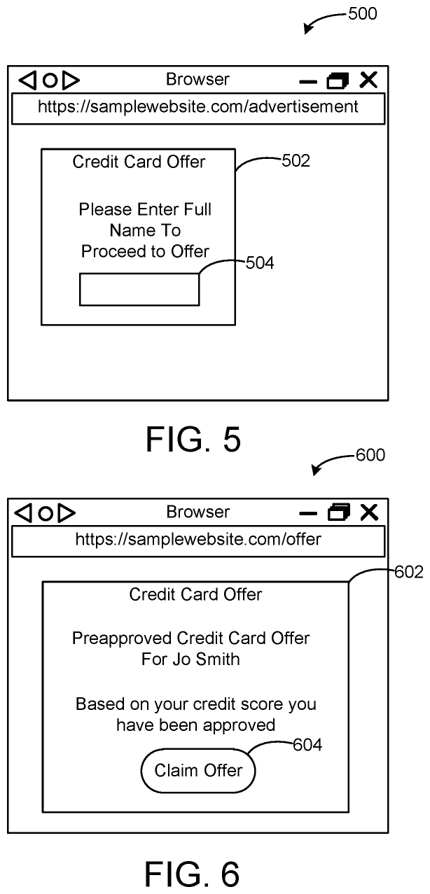

Referring now to FIG. 5, a webpage 500 displaying an advertisement is shown, according to an example embodiment. Webpage 500 can be hosted by webserver 150 and/or a webpage hosted by financial institution computing system 110 (e.g., banking site circuit 122). Reference to FIGS. 1-2 can be made to one or more components of financial institution computing system 110, webserver 150, and/or any other components of FIGS. 1-2 in explaining webpage 500. In some embodiments, advertisement 502 is generated and/or selected and displayed after a user is identified by matching circuit 124 based on at least one of a cookie identifier and/or a device identifier. Advertisement 502 can be generated and/or selected for the user based on the financial account of the user.

In some embodiments, advertisement 502 is at least one of an advertisement banner and/or a pop up advertisement. In some embodiments, once a user interacts (e.g., clicks the advertisement, hovers over the advertisement with a mouse, etc.) with the advertisement, the advertisement 502 prompts the user to enter user information into box 504. The prompt may prompt the user to enter a name, a phone number, an email address, etc. In various embodiments, advertisement 502 continuously prompts the user to enter information into box 504. Once the user enters information into box 504, advertisement 502 and/or webserver 150 can be configured to send the information to financial institution computing system 110. Financial institution computing system 110 can be configured to match the information entered into box 504 to the identified user.

Referring now to FIG. 6, a webpage 600 displaying a pre-screened credit card offer is shown, according to an example embodiment. In some embodiments, webpage 600 is related to advertisement 502 and thus reference to various components of FIG. 5 may be made in explaining FIG. 6. Webpage 600 can be created, hosted, and/or otherwise controlled by financial institution computing system 110 and/or webserver 150. Reference to various components of FIGS. 1-2 may be made in explaining webpage 600.

In some embodiments, the pre-screened advertisement 602 is displayed to a user (e.g., user 140) after they have entered their name and/or other user information into a box prompt (e.g., box 504) and matching circuit 124 has confirmed that the identity of the user determined based on device identifiers and/or cookie identifiers matches the name input to the box prompt. Pre-screened advertisement 602 can be a pre-screened credit card offer, an pre-screened loan offer, a pre-screened second mortgage offer, and/or any other offer which require a financial background check.

In some embodiments, pre-screened advertisement 602 is a pop up window. In some embodiments, pre-screened advertisement 602 is a webpage. Webpage 600 can be hosted by banking site circuit 122. When a user (e.g., user 140) clicks on credit card offer 502 and/or enters their name into box 504, a web browser operated by a computing device of the user (e.g., user device 142) can be directed to webpage 600. In some embodiments, pre-screened offer 602 is be a pop up message that is displayed on the same site as credit card offer 502.

A selection 604, can be placed on pre-screened advertisement 602. In some embodiments, the button includes text. In various embodiments, the text is “Claim Offer”, “Accept Loan”, “Apply for Credit Card”, “Learn More Info”, and/or any other text. In some embodiments, button 604 redirects a browser to a website other than the website hosting webpage 600. In some embodiments, button 604 redirects the browser to a separate page of the website hosting webpage 600. The page which button 604 redirect the web browser can allow for the user to apply, accept, enter personal information, enter user names, enter passwords, and/or any other information which financial institution 101 requires in order to allow the user (e.g., user 140) to accept the offer displayed in pre-screened offer 602.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more dedicated processors communicatively coupled to one or more dedicated memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc.

An example system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A system comprising:
a network interface configured to communicate with a webserver;
a processing circuit comprising:
an identity request handling circuit structured to:
receive, from the webserver, a first identification request and a second identification request, the first identification request comprising at least one of a corresponding request for information associated with a user associated with a user device, a corresponding device identifier, and a corresponding cookie identifier;
generate a queue comprising the first identification request and the second identification request ordered based on an average site browsing time;
a matching circuit structured to:
retrieve the first identification request from the queue and search a profile database and a failed match database based on the corresponding device identifier, and the corresponding cookie identifier;
responsive to a profile being identified in the profile database before the search of the failed match database is terminated, terminating the search of the failed match database; and
responsive to a profile being identified in the failed match database before the search of the profile database is terminated, terminate the search of the profile database; and
an advertisement generator circuit structured to:
generate an advertisement based on the profile identified by the matching circuit;
transmit the advertisement to the user device to be displayed;
prompt a user of the user device to input user identification into a user identification prompt;
receive the user identification from the user device;
corroborate the identity of the user with the user identification by at least one of: (i) causing the matching circuit to corroborate the identity of the user with the user identification based on the profile and (ii) corroborating the identity of the user based on a previously generated advertisement associated with the user determining that the user identification is associated with the profile by matching the user; and
wherein the identity request handling circuit is structured to cause the matching circuit to perform the search operations based on the first identification request and the second identification request in the queue.

2. The system of claim 1, wherein the advertisement generator circuit is further configured to prompt the user to enter the user identification into the user identification prompt in response to the user interacting with the advertisement.

3. The system of claim 1, wherein the advertisement generator circuit is further configured to generate the advertisement based on financial account information and third party data associated with the profile.

4. The system of claim 3, wherein the advertisement generator circuit is further configured to generate a pre-screened credit card advertisement when a credit score associated with the profile is above a predefined amount.

5. The system of claim 4, wherein the advertisement generator circuit is further configured to cause the pre-screened credit card advertisement to be transmitted to the user device in response to a determination that the user identification is associated with the profile.

6. The system of claim 1, wherein the advertisement generator circuit is further configured to cause a browser of the user device to be navigated to a webpage in response to the user device interacting with the advertisement;
wherein the webpage contains a pre-screened credit card offer when the user identification is associated with the profile and the credit score associated with the profile is above a predefined amount;
wherein the webpage contains a generic credit card offer when the user identification is not associated with the profile or the credit score associated with the profile is below the predefined amount.

7. The system of claim 1, wherein the matching circuit is further configured to responsive to finding at least one of the cookie identifier and the device identifier in the failed match database:
skip a search of the profile database;
generate a generic advertisement; and
transmit the generic advertisement to the user device to be displayed.

8. The system of claim 1, wherein the processing circuit is further configured to:
retrieve the device identifier from the user device;
place one or more banking cookies on the user device; and
store the user device identifier and the identity of the banking cookies in the profile stored in the profile database.

9. The system of claim 1, wherein
the processing circuit is further configured to cause the webserver to display the advertisement on the user device, wherein the webserver causes a browser of the user device to navigate the user device to a webpage when the user device interacts with the advertisement.

10. An apparatus for identifying an online user in real-time, the apparatus comprising:
a network interface configured to communicate with a user device;
a processing circuit configured to:
receive, via the network interface, a cookie identifier and a device identifier associated with the user device;
identify, in real-time, a profile associated with at least one of the cookie identifier and the device identifier by searching a profile database with at least one of the cookie identifier and the device identifier;
generate a pre-screened credit card advertisement when a credit score of the identified profile is above a predefined level;
generate a generic credit card advertisement when the credit score of the identified profile is below the predefined level;
cause, via the network interface, at least one of the pre-screened credit card advertisement and the generic credit card advertisement to be displayed on the user device;
receive user identification from the user device;
determine, in real-time, that the user identification is associated with the profile by matching the user identification with information stored in the profile.

11. The apparatus of claim 10, wherein the processing circuit is further configured to generate a user identification prompt, wherein the user is prompted to enter the user identification in response to the user interacting with the advertisement.

12. The apparatus of claim 10, wherein the processing circuit is configured to cause a browser of the user device to be navigated to a webpage in response to the user device interacting with at least one of the pre-screened credit card offer and the generic credit card offer;
wherein the webpage contains a pre-screened credit card offer when the user identification is associated with the profile and the credit score associated with the profile is above a predefined amount;
wherein the webpage contains a generic credit card offer when the user identification is not associated with the profile or the credit score associated with the profile is below the predefined amount.

13. The apparatus of claim 10, wherein the processing circuit is configured to search a failed match database with at least one of the cookie identifier and the device identifier and terminate a search of the profile database if both the cookie identifier and the device identifier are on the failed match database.

14. The apparatus of claim 10, wherein the processing circuit is configured to:
retrieve one or more user device identifier from one or more user devices associated with devices associated with an online financial account when the user devices login and authenticate with the online financial account;
place one or more banking cookies on the user devices; and
store the user device identifiers and the identity of the banking cookies in the profile stored in the profile database.

15. The apparatus of claim 10, wherein the network interface is further configured to communicate with a webserver;
wherein the processing circuit is further configured to cause the webserver to display at least one of the pre-screened credit card advertisement and the generic credit card advertisement on the user device, wherein the webserver causes a browser of the user device to navigate the user device to a webpage when the user device interacts with the advertisement.

16. A method comprising:
receiving, via a network interface, a first advertisement request, the first advertisement request including a first cookie identifier and a first device identifier associated with a user device of a user, wherein the first advertisement request is a request for an advertisement generated for the user;
receiving, via the network interface, a second advertisement request, the second advertisement request including a second cookie identifier and a second device identifier;
based on an average site browsing time of a website associated with one of the respective first cookie identifier and the second cookie identifier, generating a queue, by an identity request handling circuit, including at least the first identification request and the second identification request;
retrieving, by a matching circuit, one of the first identification and the second identification request from the queue;
searching a profiler database and a failed match database based on the respective device identifier and the respective cookie identifier;
responsive to a profile being identified in the profile database before the search of the failed match database is terminated, terminating the search of the failed match database;
responsive to a profile being identified in the failed match database before the search of the profile database is terminated, terminating the search of the profile database;
generating, by an advertisement generator circuit, an advertisement based on the profile;
causing, via the network interface, the advertisement to be displayed on the user device;
receiving, via the network interface, a user identification from the user device, wherein the advertisement prompts the user to enter the user identification into a user identification prompt; and
determining, by the processing circuit, that the user identification is associated with the profile by matching the user identification with information stored the profile
corroborating, by the advertisement generator circuit, the identity of the user with the user identification by at least one of: (i) causing the matching circuit to corroborate the identity of the user with the user identification based on the profile, and (ii) corroborating the identity of the user based on a previously generated advertisement associated with the user.

17. The method of claim 16, wherein the advertisement is configured to prompt the user to enter the user identification into the user identification prompt in response to the user interacting with the advertisement.

18. The method of claim 16, wherein the method further comprises:
causing a browser of the user device to be navigated to a webpage in response to the user device interacting with the advertisement;
wherein the webpage contains a pre-screened credit card offer when the user identification is associated with the profile and the credit score associated with the profile is above a predefined amount;
wherein the webpage contains a generic credit card offer when the user identification is not associated with the profile or the credit score associated with the profile is below the predefined amount.

19. The method of claim 16, wherein the method further comprises:
retrieving, via the network interface, the device identifier from the user device associated with an online financial account when the user device logs in and authenticates with the online financial account;
placing, via the network interface, one or more banking cookies on the user device; and
storing, by the processing circuit, the user device identifier and the identity of the banking cookies in the profile stored in the profile database.

20. The method of claim 16, the method further comprising causing a webserver to display the advertisement on the user device, wherein the webserver causes a browser of the user device to navigate the user device to a webpage when the user device interacts with the advertisement.
